(19) United States
(12) Patent Application Publication
(10) Pub. No.: US 2007/0019628 A1
(43) Pub. Date: Jan. 25, 2007

(54) Telephone switchboard apparatus and method of controlling the same

(75) Inventor: Yasufumi Tahara, Kokubunji-shi (JP)

Correspondence Address: PILLSBURY WINTHROP SHAW PITTMAN, LLP, P.O. BOX 10500, MCLEAN, VA, 22102, US

(73) Assignee: KABUSHIKI KAISHA TOSHIBA, Tokyo (JP)

(21) Appl. No.: 11/472,526

(22) Filed: Jun. 22, 2006

(30) Foreign Application Priority Data
Jun. 28, 2005 (JP) 2005-188497

(51) Int. Cl. H04L 12/66

(52) U.S. Cl. 370/352

(57) ABSTRACT

A telephone switchboard apparatus including a communications control unit which exchanges IP audio data with IP telephone terminals, an MG resource which converts the IP audio data to non-IP audio data, and vice versa, and an MG resource managing unit which manages and controls the MG resource, wherein, when a call from any one of the IP telephone terminals is found to be an emergency call, the MG resource managing unit secures and allocates the MG resource to transmission of the emergency call.

### CROSS-REFERENCE TO RELATED APPLICATIONS

This application is based upon and claims the benefit of priority from Japanese Patent Application No. 2005-188497, filed Jun. 28, 2005, the entire contents of which are incorporated herein by reference.

### BACKGROUND

1. Field

The present invention relates to a telephone switchboard apparatus which performs audio communication between telephone terminals through, for example, a local area network (LAN), and which allocates MG resources in accordance with the use priority of each telephone terminal. The invention relates also to a method of controlling the telephone switchboard apparatus.

2. Description of the Related Art

A system has been proposed, in which network telephone terminals (i.e., Vo(Voice over) Internet-protocol (IP) telephones), are connected to a LAN. Another system has been proposed. In this system, a telephone switchboard and the protocol connect a LAN to an external communications network such as the public telephone network, and any IP telephone terminal and the telephone switchboard convert the data format to perform communication between the IP telephone terminals and between any IP telephone terminal and the external communications network.

In systems of these types, a company or the like may construct a private network by using the IP network only, when it employs an IP-telephone switchboard system. Such a private network is combined, in most cases, with a non-IP private network or a non-IP public network, providing a hybrid system, either already installed. Then, the telephone switchboard must have the function of converting IP audio data (UDP packets) to non-IP audio data, and vice versa, in order to achieve calling between an IP telephone terminal and a non-IP telephone. That is, a resource (Media Gateway(MG) resource) for performing such conversion of data, e.g., digital signal processor (DSP), is indispensable. (See, for example, Jpn. Pat. Appln. KOKAI Publication 2000-184411.)

A system of the type described above may use MG resources as resource. Then, the system may not be used as many as desired for the IP telephones, due to the limited costs. Since no MG resources are vacant, the IP telephone terminals can neither transmit nor receive calls in some cases. This makes a great problem when people try to make emergency calls, dialing “911” in the United States or “119” in Japan.

### BRIEF DESCRIPTION OF THE SEVERAL VIEWS OF THE DRAWINGS

A general architecture that implements the various feature of the invention will now be described with reference to the drawings. The drawings and the associated descriptions are provided to illustrate embodiments of the invention and not to limit the scope of the invention.

FIG. 1 is a diagram schematically showing a network telephone system using a telephone switchboard according to this invention;

FIG. 2 is a block diagram depicting an IP telephone switchboard and an IP telephone terminal;

FIG. 3 is a table showing the ID numbers of IP telephone terminals, security-level data items corresponding to the ID numbers, respectively, and priority data items corresponding to the ID numbers, respectively;

FIG. 4 is a flowchart explaining a method of controlling the telephone switchboard according to this invention; and

FIG. 5 is a table showing the definition of various security levels.

### DETAILED DESCRIPTION

Various embodiments according to the invention will be described hereinafter with reference to the accompanying drawings. In general, according to one embodiment of the invention, a communications control unit which exchanges IP audio data with an IP telephone terminal; an MG resource which converts the IP audio data to non-IP audio data, and vice versa; and an MG resource managing unit which manages and controls the MG resource. If a call from the IP telephone terminal is found to be an emergency call, the MG resource managing unit will secure and allocates the MG resource transmission of the emergency call.

An embodiment of this invention will be described in detail, with reference to the accompanying drawings.

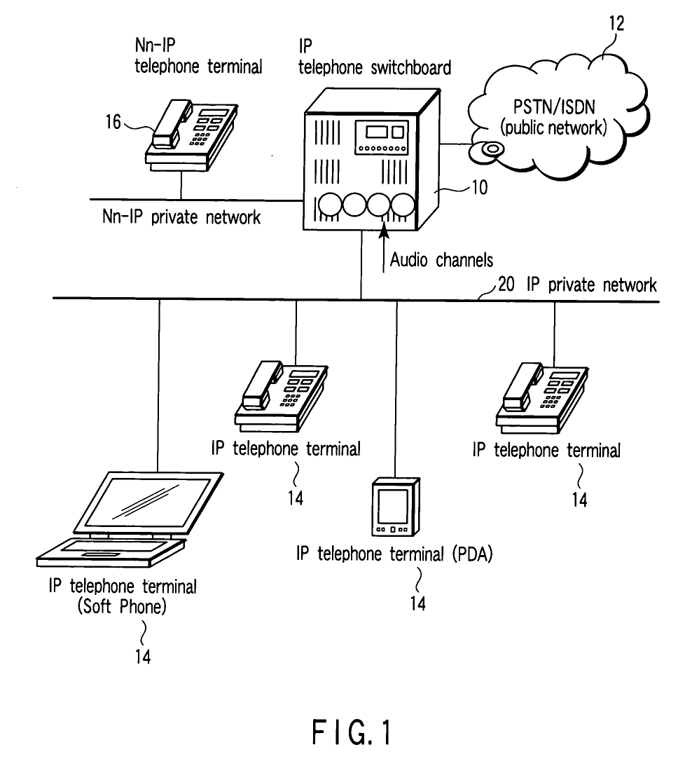

FIG. 1 is a diagram schematically showing a network telephone system that uses a telephone switchboard according to this invention.

The system has an IP private network 20 such as a local area network (LAN). A plurality of IP telephone terminals 14 are connected to the private network. Note that each IP telephone terminal 14 is a VoIP correspondence telephone.

An IP telephone switchboard 10 is connected to the IP private network 20, too. The IP telephone switchboard 10 can connect the IP telephone terminals 14 to one another on the IP private network 20 and can connect a plurality of non-IP telephone terminals 16 to an STN/ISDN (public network) 12. Further, the IP telephone switchboard 10 has a function of changing the protocol of communication between the IP private network 20 and the STN/ISDN 12 and changing the format of signals, as will be described later.

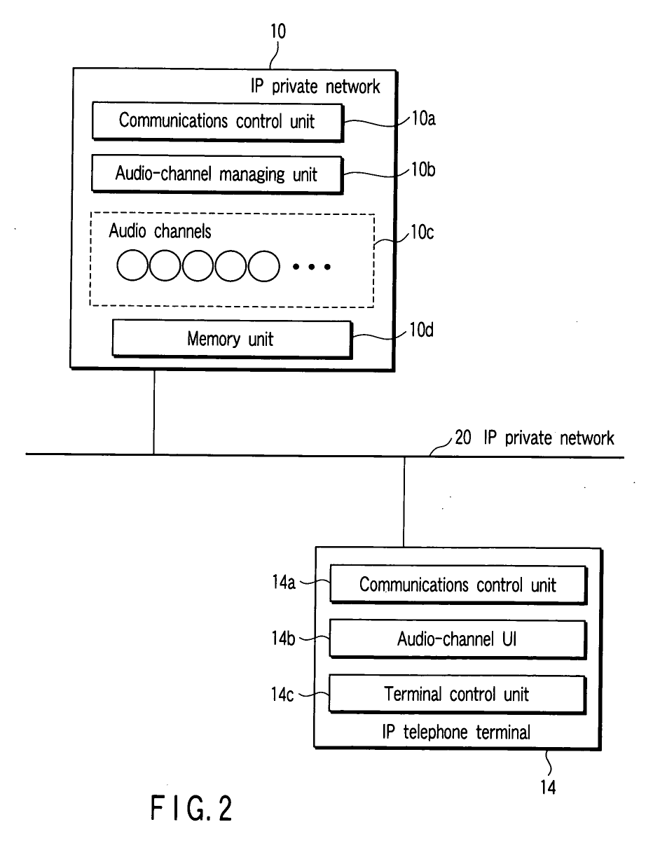

FIG. 2 is a block diagram depicting the configuration of IP telephone switchboard 10 and that of one of the IP telephone terminals 14.

The IP telephone switchboard 10 has a communications control unit 10a, an MG resource managing unit 10b, MG resources 10c, and a memory unit 10d. The IP telephone switchboard 10 transmits and receives IP audio data to and from each IP telephone terminal 14 and IP audio data. The MG resource managing unit 10b performs management and control on the MG resources 10c. The MG resources 10c are resources for achieving mutual exchange between IP audio data and non-IP audio data. The memory unit 10d stores the ID numbers assigned to the IP telephone terminals 14, the security-level data items corresponding to the ID numbers, respectively, and the priority data items corresponding to the ID numbers, respectively.

Each IP telephone terminal 14 has a communications control unit 14a, an MG resource user interface 14b (hereinafter called MG resource UI), and a terminal control unit 14c. The communications control unit 14a transmits and receives IP audio data to and from the IP telephone switchboard 10. The MG resource UI 14b functions as display/control unit and has a liquid-crystal display (LCD) and functions keys each having an LED. It can display to the user which MG resource or channels and can be operated by the user to control the components of the IP telephone terminal 14.

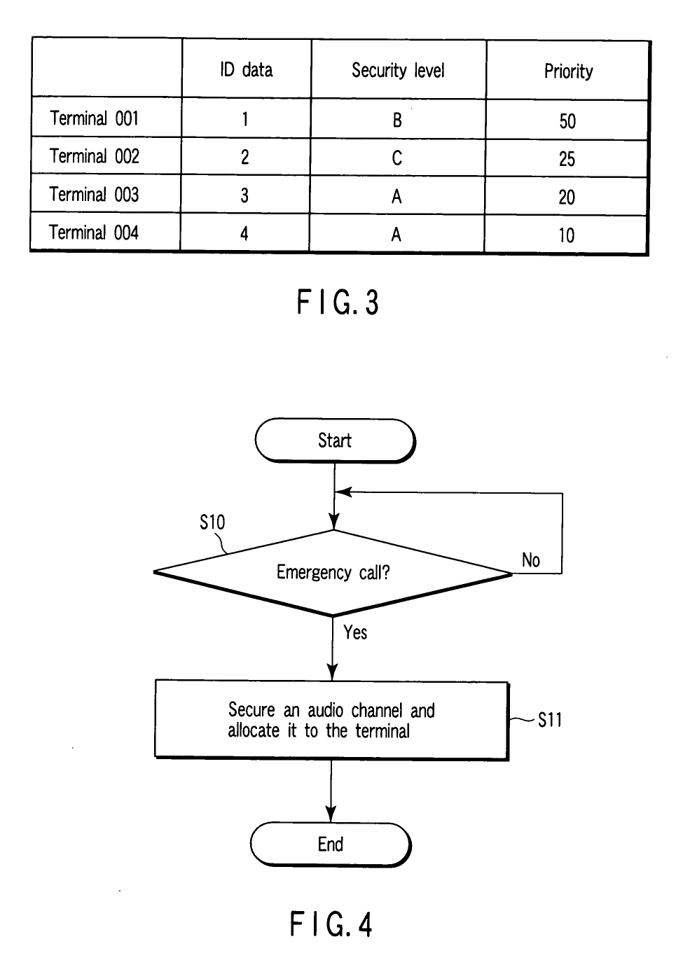

FIG. 3 is a table showing the ID numbers of IP telephone terminals, security-level data items corresponding to the ID numbers, respectively, and priority data items corresponding to the ID numbers, respectively.

As FIG. 3 shows, the IP telephone terminal 001 has ID number 1, security level B, priority 50; the IP telephone terminal 002 has ID number 2, security level CB, priority 25; the IP telephone terminal 003 has ID number 3, security level A, priority 20, and the IP telephone terminal 004 has ID number 4, security level A, priority 10.

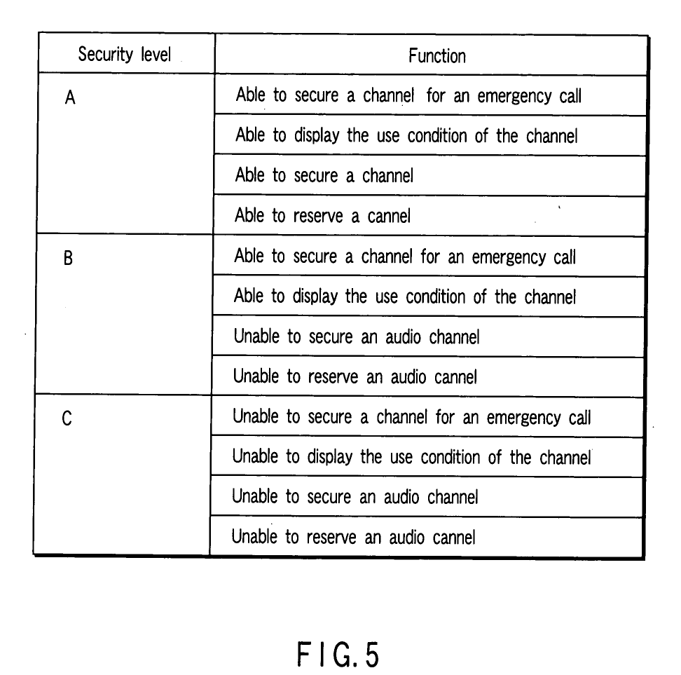

Security levels A, B and C have the relation of: C<B<A. The higher the security level any IP telephone terminal has, the more highly protected data the terminal can access. This will be described later in detail, with reference to FIG. 5.

The greater the number representing any priority, the higher the priority is. Hence, if no MG resources are available to the IP telephone terminal 14, the user operates the MG resource UI 14b, causing the MG resource managing unit 10b to reserve an MG resource. If two or more terminals 14 make reservation for MG resources, the MG resources may be assigned to the terminals 14 in accordance with the priority data items of the terminals 14.

How the telephone switchboard according to this invention is controlled in the network telephone system so configured as described above will be explained, with reference to the flowchart of FIG. 4.

Assume that a user makes an emergency call (e.g., 911 in the United States, or 119 in Japan) on an IP telephone terminal 14.

When the user makes the emergency call, the MG resource managing unit 10b of the terminal 14 determines whether the call is an emergency one (Step S10).

If it is determined in Step S10 that the call is an emergency one, the MG resource managing unit 10b force to secure one MG resource and allocates the MG resource to the emergency call (Step S11).

More specifically, when an emergency-call number (e.g., 911 or 119) is dialed on the IP telephone terminal 14, the terminal control unit 14c of the terminal 14 supplies a signal via the communications control unit 14a to the IP telephone switchboard 10, informing the switchboard 10 that an emergency call has been made.

In the IP telephone switchboard 10, the MG resource managing unit 10b receives via the communications control unit 10a the signal indicating that the communications control unit 10a has been made. The unit 10b refers to the security-level data item, the priority-data item and the like, all corresponding to the ID number of the IP telephone terminal 14, thereby determining whether it is appropriate to secure an MG resource 10c for the emergency call. If it is appropriate to do so, the unit 10b secures an MG resource 10c and transmits the emergency call through the MG resource 10c thus secured. In this case, any call being made through the MG resource 10c is interrupted. The MG resource managing unit 10b can refer to the priority-level data item, the priority-data item and the like, only when necessary. The unit 10b need not referred to them at all times, as described below. Whether it is appropriate to secure an emergency call 10c is determined by using the security-level data item, as will be explained below.

FIG. 5 is a table showing the definition of various security levels.

Assume that the MG resource managing unit 10b of the IP telephone switchboard 10 receives a via the communications control unit 10a the signal indicating that the communications control unit 10a has been made. Then, the MG resource managing unit 10b identifies the IP telephone terminal 14 making the emergency call, from the ID number of this terminal 14. More precisely, if the ID number it has received is “3,” for example, the unit 10b will determine that the IP telephone terminal 003 has made the emergency call (see FIG. 3).

The IP telephone terminal 003 has security level A. As shown in FIG. 5, security level A is: “An MG resource can be secured for the emergency.” The MG resource managing unit 10b of the IP telephone switchboard 10 therefore determines that it is appropriate to secure an MG resource 10c for the emergency call.

As shown in FIG. 5, not only a parameter as to whether an MG resource can be secured for the emergency, but also three other parameters are set in each of security levels A, B and C.

The three other parameters are: (1) whether the use condition of MG resources can be displayed or not; (2) whether MG resources can be secured or not; and (3) whether MG resources can be reserved or not.

The MG resource UI 14b will be described in detail. Recall that the MG resource UI 14b is provided in each IP telephone terminal 14 and has a liquid-crystal display (LCD) and functions keys each having an LED.

A key (hereinafter called function key) for monitoring MG resources may be assigned to an IP telephone terminal 14. In this case, the LED of this function key emits light, indicating that there are no MG resources available for any call made on the IP telephone terminal 14.

In the IP telephone switchboard 10, the MG resource managing unit 10b monitors the MG resources, determining whether they are all occupied. If all MG resources are occupied, the unit 10b supplies a signal to the IP telephone terminal 14 through the communications control unit 10a, informing the terminal 14 that all MG resources 10c are occupied.

In the IP telephone terminal 14, the terminal control unit 14c receives, via the communications control unit 14a, the signal supplied from the IP telephone switchboard 10. Thus, the unit 14c is informed that all MG resources are occupied.

The terminal control unit 14c gives an instruction to the MG resource UI 14b. Upon receiving the instruction, the MG resource UI 14b causes the LED of the function key to emit light.

Seeing the LED emitting light, the user who wants to use the IP telephone terminal 14 to make a call understands that no MG resources are available for the IP telephone terminal 14. He or she may then use a non-IP telephone terminal or a cellular telephone, instead of the IP telephone terminal 14. (In the conventional system, the user cannot find that no MG resources are available for the IP telephone terminal 14, before he or she operates the terminal 14 to make the call.

The user may allocate a function key of the MG resource UI 14b to the function of securing an MG resource. In this case, the LED of this function key emits light intermittently at the frequency of, for example, 1 Hz, when an MG resource 10C is secured.

When the user depresses the function key (i.e., a keys of the MG resource UI 14b), the terminal control unit 14c informs the IP telephone switchboard 10 of the depression of the function key. In the switchboard 10, the MG resource managing unit 10b receives this information via the communications control unit 10a and secures an MG resource 10c for the IP telephone terminal 14.

The MG resource managing unit 10b then supplies information via the communications control unit 10a to the IP telephone terminal 14, informing the terminal 14 that an MG resource 10c has been secured. In the terminal 14, the terminal control unit 14c receives this information and causes the LED of the function key to emit light intermittently.

It will be described how the process is performed if no MG resources are available for the IP telephone terminal 14.

Assume that the user allocates a function key of the MG resource UI 14b to the function of securing an MG resource. Then, the LED of this function key will emit light intermittently at the frequency of, for example, 4 Hz if an MG resource 10C is preserved, and will emit light intermittently at the frequency of, for example, 1 Hz if an MG resource 10C is secured.

In the IP telephone switchboard 10, the MG resource managing unit 10b receives, via the communications control unit 10a, a signal indicating that the function key has been depressed. Upon receiving this signal, the unit 10b tries to secure an MG resource 10c. If no MG resources 10c are available, the MG resource managing unit 10b keeps monitoring the MG resources 10c (thus, reserving an MG resource 10c) and then supplies information via the communications control unit 10a to the IP telephone terminal 14, informing the terminal 14 that it has made reservation for a MG resource 10c.

In the IP telephone terminal 14, the terminal control unit 14c receives the reservation information via the communications control unit 14a. Upon receiving this information, the unit 14c instructs the function key to emit light intermittently. Thus, the LED of the function key emits light intermittently at the frequency of, for example, 4 Hz.

When any MG resource 10c becomes available, the MG resource managing unit 10b detects this fact and secures the MG resource 10c now available. The unit 10b then supplies information via the communications control unit 10a to the IP telephone terminal 14, informing the terminal 14 that an MG resource 10c has been secured.

In the IP telephone terminal 14, the terminal control unit 14c receives, via the communications control unit 14a, the information showing that an MG resource 10c has been secured. The unit 14c then instructs the function key to emit light intermittently. The LED of the function key therefore emits light intermittently at the frequency of, for example, 1 Hz.

The MG resource UI 14b of the IP telephone terminal 14 may transmit an instruction for canceling the reservation for an MG resource. In this case, the IP telephone switchboard 10 cancels the reservation when it receives the instruction.

Thus, even if no MG resources are available for any IP telephone terminal 14, the IP telephone switchboard 10 can secure an MG resource for an emergency call made on the IP telephone terminal 14. Hence, the IP telephone terminal 14 can transmit the emergency call, though no MG resources are available for the IP telephone terminal 14.

Further, the MG resource UI 14b can display whether MG resources are available to the user. If the MG resource UI 14b displays that no MG resources are available, the user may use a non-IP telephone terminal or a cellular telephone to make a call. When an MG resource is secured for an important call that user wishes to make on the IP telephone terminal 14, the MG resource UI 14b displays this fact to the user. In this case, the IP telephone terminal 14 can transmit the important call through the MG resource secured by the IP telephone switchboard 10.

The configuration and type of the system, the configuration of the major apparatuses, the kinds of identifiers, the type of the telephone terminals, and the use restriction on the use procedure of telephone terminals, and the like can be changed within the scope and spirit of the invention.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A telephone switchboard apparatus comprising:
a communications control unit which exchanges IP audio data with IP telephone terminals;
an MG resource which converts the IP audio data to non-IP audio data, and vice versa; and
an MG resource managing unit which manages and controls the MG resource,
wherein, when a call from any one of the IP telephone terminals is found to be an emergency call, the MG resource managing unit secures and allocates the MG resource to transmission of the emergency call.

2. The telephone switchboard apparatus according to claim 1, the MG resource managing unit transmits data representing a use condition of the MG resource to any one of the IP telephone terminals, thereby causing a display control unit of the IP telephone terminal to display the use condition of the MG resource.

3. The telephone switchboard apparatus according to claim 2, wherein, when the MG resource is available, the MG resource managing unit secures the MG resource in accordance with an instruction transmitted from the display control unit.

4. The telephone switchboard apparatus according to claim 2, wherein, when the MG resource is unavailable, the MG resource managing unit reserves the MG resource in accordance with an instruction transmitted from the display control unit.

5. The telephone switchboard apparatus according to claim 1, wherein a memory unit is further provided, which stores at least one of three data items identifying each IP telephone terminal, security level of the terminal and priority of the terminal, respectively, and the MG resource managing unit refers to the data item stored in the memory unit, upon receiving an instruction from the display control unit of each IP telephone terminal, and executes the instruction when the instruction is found valid on the basis of the data item referred to.

6. The telephone switchboard apparatus according to claim 5, wherein the MG resource managing unit refers to the data item stored in the memory unit, upon receiving a plurality of instructions at the same time from the display control unit of each IP telephone terminal, and reserves IP telephone terminals in sequence in an descending order of priority when the instructions are found valid.

7. The telephone switchboard apparatus according to claim 6, wherein the MG resource managing unit cancels reservation of the MG resource upon receiving a reservation-canceling instruction from the IP telephone terminal.

8. A method of controlling a telephone switchboard apparatus comprising a communications control unit which exchanges IP audio data with IP telephone terminals, an MG resource which converts the IP audio data to non-IP audio data, and vice versa, and an MG resource managing unit which manages and controls the MG resource, said method comprising:
determining whether a call from any one of the IP telephone terminals is an emergency call; and
securing and allocating the MG resource to transmission of the emergency call.
